(19) United States
(12) Patent Application Publication
(10) Pub. No.: US 2026/0202807 A1
(43) Pub. Date: Jul. 16, 2026

(54) SWITCH AND LOAD METERING FUNCTION CONTROL METHOD

(71) Applicant: LUMI UNITED TECHNOLOGY CO., LTD., Shenzhen (CN)

(72) Inventors: Qiang YANG, Shenzhen (CN); Qi LU, Shenzhen (CN); Feng HUANG, Shenzhen (CN)

(73) Assignee: Lumi United Technology Co., Ltd., Shenzhen, GD (CN)

(21) Appl. No.: 19/023,074

(22) Filed: Jan. 15, 2025

(51) Int. Cl. G05B 15/02

(52) U.S. Cl. CPC G05B 15/02

(57) ABSTRACT

The various embodiments of the present application provide a switch, which includes: a first detection circuit, a control circuit, and a power extraction circuit; wherein, the first detection circuit is configured to detect an operating mode of the switch; the operating mode includes a first mode and a second mode; the control circuit is connected to the first detection circuit and the power extraction circuit, and is configured to control the power extraction circuit to draw power according to the corresponding power extraction mode based on the operating mode of the switch. The embodiments of the present application solve the problem that exists in the related art, where the single with neutral universal switch is not yet capable of providing a rich set of functional circuits, leading to a low usage rate.

### TECHNICAL FIELD

The present application pertains to the domain of smart switches, specifically, the present application is concerned with a switch and a load metering function control method.

### BACKGROUND

Smart switches, as the most frequently used and critically controlled component in homes, have long been an indispensable foundational product in smart home systems. Typically, smart switches are equipped with a microcontroller module, which requires continuous power supply to ensure its normal operation, whether the smart switch is turned on or off. Currently, smart switches available on the market are categorized into no-neutral wire switches, with neutral wire switches, and universal single-with neutral switches.

Existing universal single-with neutral switches are powered by batteries for the microcontroller and other internal circuits of the switch. Due to the limited battery capacity, there are two main issues: on one hand, batteries need to be replaced regularly, and on the other hand, the internal power consumption of the switch cannot be too high, otherwise, batteries would need to be replaced more frequently. This leads to the necessity for the universal single-with neutral switches to forgo some power-consuming functional circuits, such as a metering circuit used for measuring the electrical parameters of the load.

As mentioned above, the universal single-with neutral switches are still unable to provide a rich set of functional circuits, which results in a lower usage rate.

### SUMMARY OF THE DISCLOSURE

The present application provides various embodiments of a switch that can address the issue in the related art where the universal single-with neutral switches are unable to provide a rich set of functional circuits, leading to a low usage rate. The technical solution is as follows:

According to an aspect of the present application, a switch is provided, which includes: a first detection circuit, a control circuit, and a power extraction circuit; wherein, the first detection circuit is configured to detect an operating mode of the switch; the operating mode includes a first mode and a second mode; the control circuit, is connected to the first detection circuit and the power extraction circuit, and is configured to control the power extraction circuit to draw power according to a corresponding power extraction mode based on the operating mode of the switch.

In an exemplary embodiment, the first detection circuit includes a detection signal output module; the detection signal output module is configured to output a first detection signal when the switch is not connected to a neutral wire, and transmit the first detection signal to the control circuit, causing the control circuit to determine the operating mode of the switch as the first mode; or, to output a second detection signal when the switch is connected to a neutral wire, and transmit the second detection signal to the control circuit, causing the control circuit to determine the operating mode of the switch as the second mode.

In an exemplary embodiment, the first detection circuit further includes a voltage input module and an isolation module; wherein, the voltage input module is configured to transmit a high voltage signal to the isolation module when a neutral wire terminal of the switch is connected to the neutral wire; or, to stop transmitting the high voltage signal to the isolation module when the neutral wire terminal of the switch is not connected to the neutral wire; the isolation module is configured to generate a first low voltage signal or a second low voltage signal based on whether the voltage input module outputs the high voltage signal, and transmit the first low voltage signal or the second low voltage signal to the detection signal output module; the detection signal output module is configured to correspondingly generate a detection signal based on the first low voltage signal or the second low voltage signal, and transmit the detection signal to the control circuit, causing the control circuit to determine the operating mode of the switch based on the detection signal.

In an exemplary embodiment, the isolation module includes an optocoupler unit; wherein, when an input terminal of the optocoupler unit receives the high voltage signal output by the voltage input module, an output terminal of the optocoupler unit is conductive, to generate the first low voltage signal; when the input terminal of the optocoupler unit does not receive the high voltage signal output by the voltage input module, the output terminal of the optocoupler unit is disconnected, to generate the second low voltage signal.

In an exemplary embodiment, the detection signal output module includes a detection switch element and a detection-limiting current element; wherein, a control terminal of the detection switch element is configured to receive the first low voltage signal or the second low voltage signal, causing an input terminal and an output terminal of the detection switch element is conductive or disconnected based on the first low voltage signal or the second low voltage signal; one terminal of the detection-limiting current element is connected to the output terminal of the detection switch element, and an other terminal connected to a power supply terminal, configured to correspondingly output the detection signal when the detection switch element is conductive or disconnected.

In an exemplary embodiment, the power extraction circuit is connected to a live wire terminal and/or a neutral wire terminal of the switch, configured to draw power according to the power extraction mode corresponding to the operating mode of the switch and supply power to the switch; the power extraction circuit includes a first power extraction circuit and a second power extraction circuit; when the operating mode of the switch is the first mode, the first power extraction circuit draws power from the live wire terminal of the switch according to the first power extraction mode corresponding to the first mode, causing the switch to enter a first power consumption mode; when the operating mode of the switch is the second mode, the second power extraction circuit draws power from the live wire terminal and the neutral wire terminal of the switch according to the second power extraction mode corresponding to the second mode, causing the switch to enter a second power consumption mode; power consumption in the second power consumption mode is higher than that in the first power consumption mode.

In an exemplary embodiment, the first power extraction circuit includes a first power extraction conversion component and a first power extraction switch component, wherein, through the first power extraction conversion component, an input voltage of the first power extraction circuit is converted into a first voltage, and the switch is powered through the first power extraction switch component.

In an exemplary embodiment, the second power extraction circuit includes a second power extraction conversion component and a second power extraction switch component, wherein, through the second power extraction conversion component, input voltage of the second power extraction circuit is converted into a second voltage, and the switch is powered through the second power extraction switch component.

In an exemplary embodiment, the switch further includes a relay control circuit connected to the control circuit, the relay control circuit includes a relay, the relay control circuit is configured to control the relay to conduct under control of the control circuit, to control operation of a load connected to the switch by conduction of the relay.

In an exemplary embodiment, the switch further includes a functional circuit connected to the power extraction circuit; a power extraction modes include a first power extraction mode and a second power extraction mode; wherein, the power extraction circuit, under the first power extraction mode, is configured to output a first voltage to the functional circuit; or, under the second power extraction mode, is configured to output a second voltage to the functional circuit; the first voltage is lower than the second voltage.

In an exemplary embodiment, the functional circuit includes at least one of the following: a metering circuit, configured to measure electrical parameters of a load connected to the switch; an indication circuit, configured to indicate the operating mode of the switch; a communication circuit, configured to communicate between all circuits within the switch.

In an exemplary embodiment, the switch further includes: a second detection circuit and a metering circuit, the second detection circuit is configured to detect a power extraction method of the switch; the power extraction method includes a first power extraction method and a second power extraction method; the control circuit, is connected to the metering circuit, and is configured to control the metering circuit to initiate a load metering function, based on the operating mode and/or the power extraction method of the switch.

In an exemplary embodiment, the second detection circuit includes a first power supply circuit, a second power supply circuit, and a sampling circuit; wherein, the first power supply circuit, is configured to output a first power supply signal to the sampling circuit when the switch is electrically connected to a load, causing the sampling circuit to sample the first power supply signal; the second power supply circuit, is configured to output a second power supply signal to the sampling circuit when the switch is disconnected from the load, causing the sampling circuit to sample the second power supply signal; the sampling circuit, configured to output a sampling signal by sampling the first power supply signal or the second power supply signal, and transmit the sampling signal to the control circuit, causing the control circuit to determine the power extraction method of the switch based on the sampling signal.

In an exemplary embodiment, the first power supply circuit includes a first power supply conversion component and a first power supply switch component, wherein, through the first power supply conversion component, a AC supply voltage is converted into a first power supply voltage, which is then transmitted to the sampling circuit via the first power supply switch component; and/or the second power supply circuit includes a second power supply conversion component and a second power supply switch component, wherein, through the second power supply conversion component, the AC supply voltage is converted into a second power supply voltage, which is then transmitted to the sampling circuit via the second power supply switch component.

In an exemplary embodiment, the sampling circuit includes a comparator, the comparator is connected to the first power supply circuit and the second power supply circuit, is configured to compare the first power supply signal or the second power supply signal with a threshold signal, generate a sampling signal, and transmit it to the control circuit; and/or the sampling circuit includes a first current-limiting component and a second current-limiting component, one terminal of the first current-limiting component and one terminal of the second current-limiting component are connected in series, an other terminal of the first current-limiting component is connected to the first power supply circuit and the second power supply circuit, an other terminal of the second current-limiting component is grounded, and the sampling signal is output at a series connection point of the first current-limiting component and second current-limiting component.

In an exemplary embodiment, the metering circuit includes a power supply module, a voltage output module, and a load metering module; wherein, the power supply module, connected to the voltage output module, is configured to output a power supply voltage to the voltage output module; the voltage output module, connected to the control circuit, is configured to supply power to the load metering module based on the power supply voltage outputted by the power supply module under control of the control circuit; the load metering module, configured to measure electrical parameters of the load and transmit measured electrical parameters to the control circuit.

In an exemplary embodiment, the voltage output module includes a linear regulator; an input terminal of the linear regulator is connected to the power supply module, an output terminal of the linear regulator supplies power to the load metering module, and an enable terminal of the linear regulator is connected to the control circuit; the control circuit controls the enable terminal of the linear regulator, to control linear regulator supply power to the load metering module.

In an exemplary embodiment, the voltage output module includes a third power supply switch component; one terminal of the third power supply switch component is connected to the power supply module, an other terminal of the third power supply switch component is connected to the load metering module, and a control terminal of the third power supply switch component is connected to the control circuit; the control circuit is configured to control the third power supply switch component to conduct, causing the power supply voltage outputted by the power supply module transmitted to the load metering module.

According to an aspect of the present application, a load metering function control method, applied to the switch, the method including: detecting the operating mode and the power extraction method of the switch; controlling the metering circuit within the switch to initiate the load metering function based on the operating mode and/or the power extraction method of the switch.

In an exemplary embodiment, controlling the metering circuit within the switch to initiate the load metering function based on the operating mode and/or the power extraction method of the switch includes: when the operating mode of the switch is the second mode, controlling the metering circuit to initiate the load metering function; when the operating mode of the switch is the first mode, controlling the metering circuit to initiate the load metering function based on the power extraction method of the switch.

In an exemplary embodiment, when the operating mode of the switch is the first mode, controlling the metering circuit to initiate the load metering function based on the power extraction method of the switch includes: when the operating mode of the switch is the first mode, and the power extraction method of the switch is the second power extraction method, controlling the metering circuit to deactivate the load metering function; when the power extraction method of the switch is the first power extraction method, controlling the metering circuit to initiate the load metering function.

The beneficial effects brought by the technical solution provided in the present application are as follows:
in the technical solution described above, the switch includes a first detection circuit, a control circuit, and a power extraction circuit. Within this switch, the first detection circuit is configured to detect the operating mode of the switch, enabling the control circuit to control the power extraction circuit to draw power using the corresponding power extraction mode based on the switch's operating mode: when the switch is in the first mode, the power extraction circuit draws power according to the first power extraction mode from the live wire terminal of the switch, allowing the switch to operate at low power consumption, that is, reducing the power consumption of the internal functional circuits of the switch, such as deactivating the power metering circuit; when the switch is in the second mode, the power extraction circuit draws power according to the second power extraction mode from both the live wire and neutral wire terminals of the switch, allowing the switch to operate at high power consumption, such as activating the power metering circuit. This approach avoids the need for battery power supply, eliminating the need for regular battery replacement, and prevents the switch from having to forgo some power-consuming functional circuits. It effectively addresses the issue in the related art where universal single-with neutral switches are unable to provide a rich set of functional circuits, which has led to a low usage rate.

### BRIEF DESCRIPTION OF THE DRAWINGS

To provide a clear explanation of the technical solutions in the embodiments of the present application, a brief introduction to the figures used in the description is as follows:

FIG. 1 is a block diagram of the power supply for a smart switch in the existing technology.

FIG. 2 is a structural schematic diagram of the switch involved in the embodiments of the present application.

FIG. 3 is a structural schematic diagram of a first detection circuit according to an exemplary embodiment.

FIG. 4 is another structural schematic diagram of a first detection circuit according to an exemplary embodiment.

FIG. 5 is yet another structural schematic diagram of a first detection circuit according to an exemplary embodiment.

FIG. 6 is a structural schematic diagram of a power extraction circuit according to an exemplary embodiment.

FIG. 7 is another structural schematic diagram of the switch according to an exemplary embodiment.

FIG. 8 is a structural schematic diagram of yet another switch provided in the embodiments of the present application.

FIGS. 9A and 9B are structural schematic diagrams of the first detection circuit in another exemplary embodiment.

FIG. 10 is a structural schematic diagram of a second detection circuit in an exemplary embodiment.

FIG. 11 is a schematic diagram showing the specific implementation of a first power supply circuit and a second power supply circuit in an exemplary embodiment.

FIG. 12 is a schematic diagram showing the specific implementation of a sampling circuit in an exemplary embodiment.

FIG. 13 is a structural schematic diagram of a metering circuit in an exemplary embodiment.

FIG. 14 is a flowchart of a load metering function control method according to an exemplary embodiment.

FIG. 15 is a flowchart of step 920 in the embodiment corresponding to FIG. 14.

FIG. 16 is a flowchart of step 1020 in the embodiment corresponding to FIG. 15.

FIG. 17 is a schematic diagram showing the specific implementation of the load metering function control method in an exemplary embodiment.

### DETAILED DESCRIPTION

The following is a detailed description of the embodiments of the present application. The examples in the embodiments are shown in the accompanying drawings, in which the same or similar reference numerals throughout represent the same or similar elements or elements with the same or similar functions. The embodiments described with reference to the drawings are exemplary and are used for explaining the present application, but should not be interpreted as limitations on the present application.

Persons skilled in the art in this technical field will understand that, unless specifically stated, the singular forms “a,” “an,” “the,” and “said” used here can also include plural forms. It should be further understood that the term “comprising” as used in the specification of the present application means that the features, integers, steps, operations, elements, and/or components are present, but does not exclude the presence or addition of one or more other features, integers, steps, operations, elements, components, and/or their groups. It should be understood that when we refer to an element being “connected” or “coupled” to another element, it can be directly connected or coupled to other elements, or there may be intermediate elements. Furthermore, “connected” or “coupled” as used here can include wireless connections or wireless coupling. The term “and/or” used here includes all or any combination of the listed associated items, either singularly or in combination.

Below are introductions and explanations of several terms involved in the present application:
A no-neutral switch: refers to a switch that can operate by connecting only the live wire and the load wire.
A with neutral switch: refers to a switch that requires the simultaneous connection of the live wire, the load wire, and the neutral wire to operate.
An universal single-with neutral switch: refers to a switch that can operate by connecting only the live wire, or by connecting both the live wire and the neutral wire.

An operating mode includes a first mode and a second mode. Specifically, the first mode refers to the live wire mode, where the switch draws power from the live wire only; the second mode refers to the with neutral mode, where both the neutral wire and the live wire of the switch are connected to the power extraction circuit.

A power extraction mode includes a first power extraction mode and a second power extraction mode. Specifically, the first power extraction mode refers to the power extraction circuit drawing power from the live wire terminal of the switch; the second power extraction mode refers to the power extraction circuit drawing power from both a live wire terminal and a neutral wire terminal of the switch.

A power extraction method includes a first power extraction method and a second power extraction method. Specifically, the first power extraction method refers to the on-state power extraction method (load on), and the second power extraction method refers to the off-state power extraction method (load off).

As mentioned earlier, smart switches are divided into no-neutral switches, with neutral switches, and universal single-with neutral switches.

Among them, the universal single-with neutral switch can adapt to both no-neutral wiring and with neutral wiring, and is powered by a battery to supply the microcontroller and functional circuits inside the switch.

As shown in FIG. 1, the universal single-with neutral switch consists of several components, including a relay, a relay control circuit, a battery power supply circuit, and a MCU (Microcontroller). Among them, the MCU is powered by the battery through the battery power supply circuit, and the MCU controls the conduction and disconnection of the relay through the relay control circuit, thereby achieving intelligent control of the switch.

On one hand, the capacity of the battery is limited and requires periodic replacement. On the other hand, the power consumption of the switch cannot be too high; otherwise, the battery would need to be replaced more frequently. To reduce the frequency of replacement, the universal single-with neutral switch has to forgo some high-power-consuming functional circuits.

To avoid using battery power, the inventor proposes to power the switch according to the power extraction modes of no-neutral switches and with neutral switches. However, the inventor also realizes that this power extraction mode still has the following drawbacks:

The no-neutral switch achieves power drawing by forming a circuit between the live wire terminal and the load, which may result in the “ghost fire” phenomenon for low-power loads, such as light bulbs. This occurs when the internal microcontroller's operational power flows through the light fixture after controlling low-power energy-saving lamps or LED lights to turn off, causing the light to flicker or dimly glow, resulting in unnecessary power consumption.

While the with neutral switch does not exhibit the “ghost fire” phenomenon, it requires both the live wire and the neutral wire to be connected to operate. Since most houses use no-neutral switches, the with neutral switch cannot adapt to all housing situations, resulting in poor universality.

To this end, the switch provided by the present application can solve the aforementioned problems.

In order to make the objectives, technical solutions, and advantages of the present application clearer, the following will provide a further detailed description of the embodiment of the present application in conjunction with the accompanying drawings.

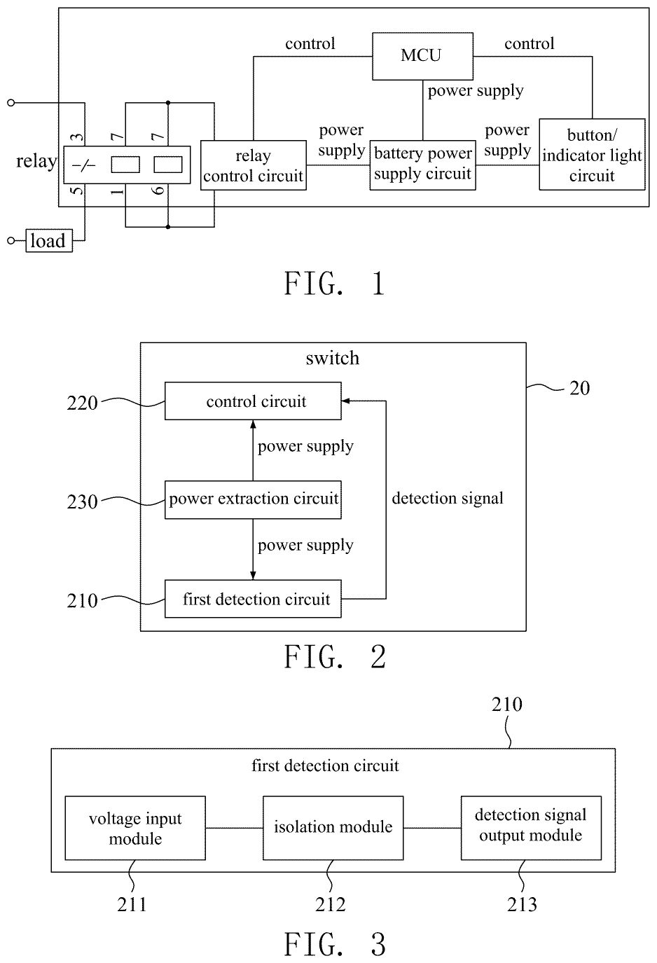

In an exemplary embodiment of the switch, as shown in FIG. 2, a switch 20 is illustrated, which includes a first detection circuit 210, a control circuit 220, and a power extraction circuit 230.

The first detection circuit 210 is configured to detect the operating mode of the switch 20, which includes a first mode and a second mode. Specifically, the first mode refers to the live wire mode, where the switch only has the live wire connected to the power extraction circuit; the second mode refers to the with neutral mode, where both the neutral wire and the live wire of the switch are connected to the power extraction circuit 230.

The control circuit 220 is connected to both the first detection circuit 210 and the power extraction circuit 230, and is configured to control the power extraction circuit 230 to draw power according to the corresponding power extraction mode based on the operating mode of the switch 20.

The power extraction mode includes a first power extraction mode and a second power extraction mode. Specifically, the first power extraction mode refers to the power extraction circuit drawing power from the live wire terminal of the switch; the second power extraction mode refers to the power extraction circuit drawing power from both the live wire terminal and the neutral wire terminal of the switch.

The power extraction circuit 230 is connected to the live wire terminal and/or neutral wire terminal of the switch 20 and is configured to draw power according to the power extraction mode corresponding to the operating mode of the switch 20, thereby supplying power to the switch 20, as shown in FIG. 2. After drawing power, the power extraction circuit 230 supplies power to the control circuit 220 and the first detection circuit 210 within the switch 20. In one possible implementation, after being powered, the switch 20 can enter a first power consumption mode, which reduces the power consumption of various internal circuits; it can also enter a second power consumption mode, which allows for greater power consumption of the internal circuits. It is noted that the power consumption of the internal circuits in the second power consumption mode is higher than that in the first power consumption mode.

For example, if the operating mode of the switch 20 is the first mode, the corresponding power extraction mode is the first power extraction mode. At this time, the power extraction circuit draws power from the live wire terminal of the switch according to the first power extraction mode and supplies power to the switch 20, causing it to enter the first power consumption mode, thereby avoiding the occurrence of the “ghost fire” phenomenon.

Based on the above circuits, different power extraction modes for the switch are achieved. That is, when the operating mode of the switch is the first mode, the power extraction circuit draws power from the live wire terminal of the switch according to the first power extraction mode, allowing the switch to enter the first power consumption mode, which reduces the power consumption of the internal functional circuits, such as turning off the metering circuit. When the operating mode of the switch is the second mode, the power extraction circuit draws power from both the live wire terminal and the neutral wire terminal of the switch according to the second power extraction mode, allowing the switch to enter the second power consumption mode, such as activating the metering circuit. This avoids the need for battery power supply, eliminating the need for periodic battery replacement and the necessity for the switch to forgo some high-power-consuming functional circuits. This effectively solves the problem that the existing universal single-with neutral switches in related technologies cannot provide a rich set of functional circuits, resulting in lower usage rates.

In an exemplary embodiment, the first detection circuit includes a detection signal output module; wherein, the detection signal output module is configured to output a first detection signal when the switch is not connected to the neutral terminal, and transmit the first detection signal to the control circuit, causing the control circuit to determine that the operating mode of the switch is the first mode; or, when the switch is connected to the neutral terminal, output a second detection signal and transmit the second detection signal to the control circuit, causing the control circuit to determine that the operating mode of the switch is the second mode.

Specifically, in an exemplary embodiment as shown in FIG. 3, the first detection circuit 210 includes a voltage input module 211, an isolation module 212, and a detection signal output module 213.

The voltage input module 211 is configured to transmit a high voltage signal to the isolation module when the neutral terminal is connected to the switch's neutral terminal; or, stop transmitting a high voltage signal to the isolation module when the neutral terminal of the switch is not connected to the neutral terminal.

The isolation module 212 is configured to generate a first low voltage signal or a second low voltage signal based on whether the voltage input module outputs a high voltage signal, and transmit the first low voltage signal or the second low voltage signal to the detection signal output module.

The detection signal output module 213 is configured to generate a corresponding detection signal based on the first low voltage signal or the second low voltage signal, and transmit the detection signal to the control circuit, causing the control circuit to determine the operating mode of the switch based on the detection signal.

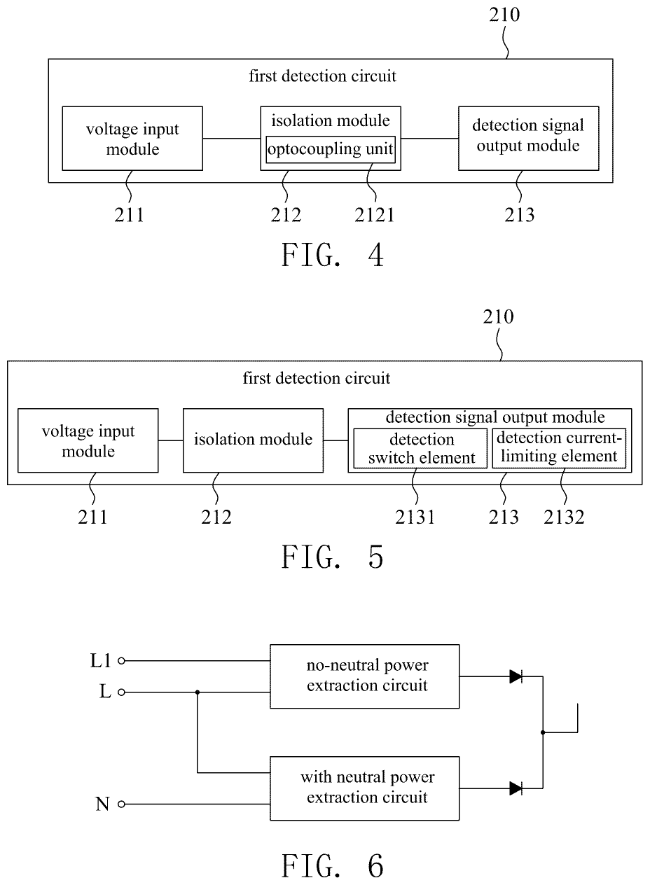

In one possible implementation as shown in FIG. 4, the aforementioned isolation module 212 includes an optocoupling unit 2121. If the input terminal of the optocoupling unit 2121 receives a high voltage signal output by the voltage input module 211, the output terminal of the optocoupling unit 2121 is conductive, generating a first low voltage signal. If the input terminal of the optocoupling unit 2121 does not receive a high voltage signal output by the voltage input module 211, the output terminal of the optocoupling unit is open-circuited, generating a second low voltage signal.

In one possible implementation as shown in FIG. 5, the aforementioned detection signal output module 213 includes a detection switch element 2131 and a detection current-limiting element 2132. The control terminal of the detection switch element 2131 is configured to receive the first low voltage signal or the second low voltage signal output by the isolation module 212, causing the input terminal and output terminal of the detection switch element 2131 to be conductive or open-circuited based on the first low voltage signal or the second low voltage signal; one terminal of the detection current-limiting element 2132 is connected to the output terminal of the detection switch element 2131, and the other terminal is connected to the power supply terminal, configured to output a corresponding detection signal when the detection switch element 2132 is conductive or open-circuited.

The following uses an optocoupling unit 2121 including a photoelectric coupler, a detection switch element 2131 including a MOS transistor, and a detection current-limiting element 2132 including several resistors as examples for illustration, but this does not constitute a specific limitation.

In the first example, the optocoupler unit 2121 includes a first photoelectric coupler, the detection switch element 2131 includes a first MOS transistor, and the detection current-limiting element 2132 includes a first resistor and a second resistor.

Specifically, the first input terminal and the second input terminal of the first photoelectric coupler are respectively connected to the live terminal and the neutral terminal of the switch, the first output terminal of the first photoelectric coupler is connected to a low voltage level, the second output terminal of the first photoelectric coupler is respectively connected to one end of the first resistor, one end of the first capacitor, and the gate of the first MOS transistor, the other end of the first resistor is connected to one end of the second resistor, the other end of the first capacitor is connected to the ground terminal, the drain of the first MOS transistor is connected to the other end of the second resistor, the source of the first MOS transistor is connected to the ground terminal, and the connection point of the first resistor and the second resistor is connected to the power supply terminal.

When the neutral terminal of switch 20 is not connected to the neutral wire, the first photoelectric coupler's first input terminal and second input terminal do not have a high voltage signal input, the second output terminal and the first output terminal are in an open-circuit state, generating a first low voltage signal and transmitting it to the gate of the first MOS transistor. At this time, the voltage between the gate and the source of the first MOS transistor is pulled up to 3.3V by the input of the power supply terminal. Since 3.3V is greater than the conduction voltage of the first MOS transistor (0.7V), the drain and source of the first MOS transistor are conductive, and accordingly, the detection signal is pulled down to 0V.

At this time, the control circuit detects that the detection signal is at a low voltage level and determines that the operating mode of the switch is the first mode.

When the neutral terminal of switch 20 is connected to the neutral wire, the high voltage signal input between the live wire and the neutral wire is the 220V grid voltage. The first input terminal and the second input terminal of the first photoelectric coupler detect the high voltage signal, making the second output terminal and the first output terminal conductive, generating a second low voltage signal and transmitting it to the gate of the first MOS transistor. At this time, the gate of the first MOS transistor, due to being connected to the second low voltage signal, is pulled down to 0V. The voltage between the gate and the source is less than the conduction voltage of the first MOS transistor, causing the drain and source of the first MOS transistor to be cut off, and accordingly, the detection signal is pulled up to 3.3V.

At this time, the control circuit detects that the detection signal is at a high voltage level and determines that the operating mode of the switch is the second mode.

In the second example, the optocoupler unit 2121 includes a second photoelectric coupler, the detection switch element 2131 includes a second MOS transistor, and the detection current-limiting element 2132 includes a third resistor, a fourth resistor, a fifth resistor, and a sixth resistor.

Specifically, the first input terminal and the second input terminal of the second photoelectric coupler are respectively connected to the live terminal and the neutral terminal of the switch, the first output terminal of the second photoelectric coupler is respectively connected to the gate of the second MOS transistor and one end of the sixth resistor, the second output terminal of the second photoelectric coupler is connected to the power supply terminal, at the same time, the source of the second MOS transistor and the other end of the sixth resistor are connected and then connected to the ground terminal low voltage level, the drain of the second MOS transistor is connected to the power supply terminal through the third resistor, the fifth resistor and the second capacitor are parallel connected, one end is connected to the drain of the second MOS transistor through the fourth resistor, and the other end is connected to the control circuit.

When the neutral terminal of switch 20 is not connected to the neutral wire, the second photoelectric coupler does not output a high voltage signal, thus the second MOS transistor is cut off, and the detection signal output module outputs a detection signal with a voltage V_DET=3.3V/(R16/(R16+R15+R14)), where R16 is the resistance value of the fifth resistor, R15 is the resistance value of the fourth resistor, and R14 is the resistance value of the third resistor.

When the neutral terminal of switch 20 is connected to the neutral wire, the high voltage signal output by the second photoelectric coupler is a sine wave, then the second MOS transistor conducts and cuts off at a frequency of 50 Hz. When the duty cycle is D, the detection signal output module outputs a detection signal with a voltage V_DET=3.3V/(R16/(R16+R15+R14))*D.

At this point, the control circuit can determine the operating mode of the switch based on the different voltage levels of the detection signal V_DET, thereby controlling the power extraction circuit to draw power according to the power extraction mode corresponding to the switch's operating mode to supply power to the switch.

Based on the above circuit, on the one hand, the high voltage input from the live and neutral terminals of the switch and the low voltage inside the switch are isolated using optical coupling, which has high reliability and meets safety requirements. On the other hand, the detection signal outputs a high level when the neutral wire is connected, and a low level when there is no neutral wire connected, making the control circuit's judgment logic simple and greatly facilitating the use of the control circuit.

Please refer to FIG. 6, in an exemplary embodiment, the power extraction circuit, connected to the live and/or neutral terminals of the switch, is configured to supply power to the switch after drawing power according to the power extraction mode corresponding to the switch's operating mode; the power extraction circuit includes a first power extraction circuit and a second power extraction circuit.

Among them, the first power extraction circuit is a no-neutral power extraction circuit, drawing power according to the first power extraction mode; the second power extraction circuit is a with neutral power extraction circuit, drawing power according to the second power extraction mode.

Specifically, if the switch's operating mode is the first mode, the first power extraction circuit draws power from the switch's live terminal L/L1 according to the first power extraction mode corresponding to the first mode, causing the switch to enter the first power consumption mode.

In one possible implementation, the first power extraction circuit includes a first power extraction conversion component and a first power extraction switch component, wherein the input voltage of the first power extraction circuit is converted into a first voltage through the first power extraction conversion component, and is supplied to the switch through the first power extraction switch component.

If the switch's operating mode is the second mode, the second power extraction circuit draws power from the switch's live terminal L and neutral terminal N according to the second power extraction mode corresponding to the second mode, causing the switch to enter the second power consumption mode.

In one possible implementation, the second power extraction circuit includes a second power extraction conversion component and a second power extraction switch component, wherein the input voltage of the second power extraction circuit is converted into a second voltage through the second power extraction conversion component, and is supplied to the switch through the second power extraction switch component.

Based on the above circuit, the switch is made to operate in different power consumption modes, thereby allowing the deployment of a rich set of functional circuits in the switch. That is, when drawing power from the switch's live terminal, the switch is allowed to enter the first power consumption mode, reducing the power consumption of the switch's internal functional circuits, such as turning off the metering circuit; when drawing power from the switch's live terminal and neutral terminal, the switch is allowed to enter the second power consumption mode, such as activating the metering circuit, thus avoiding the switch to forgo some high-power-consuming functional circuits, and effectively improving the usage rate of the switch and enriching the application scenarios of the switch.

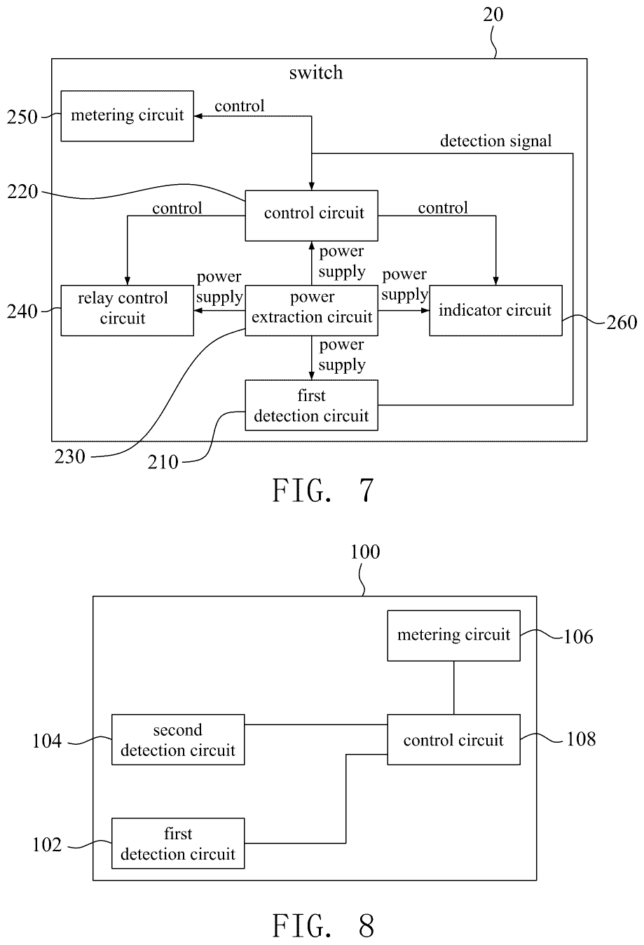

Please refer to FIG. 7, in an exemplary embodiment, switch 20 also includes a relay control circuit 240 connected to the control circuit 220, which relay control circuit includes a relay, and controls the relay to conduct under the control of the control circuit 220, thereby controlling the operation of the load connected to switch 20 through the conduction of the relay.

In an exemplary embodiment, switch 20 also includes a functional circuit connected to the power extraction circuit 230, and the power extraction mode includes a first power extraction mode and a second power extraction mode; wherein, the power extraction circuit 230 outputs a first voltage to the functional circuit in the first power extraction mode; or, outputs a second voltage to the functional circuit in the second power extraction mode; the first voltage is lower than the second voltage.

In other words, when powering switch 120 with the first voltage, the switch enters the first power consumption mode to avoid the occurrence of the “ghost fire” phenomenon; when powering switch 120 with the second voltage, the switch enters the second power consumption mode, allowing for the deployment of richer functional circuits in the switch to increase the usage rate of the switch.

Continuing to refer to FIG. 7, the aforementioned functional circuit includes, but is not limited to, one or more of a metering circuit, an indicator circuit, and a communication circuit.

The metering circuit 250 is used to measure the electrical parameters of the load connected to switch 20. These electrical parameters include, but are not limited to: current, voltage, power, etc.

The indicator circuit 260 is used to indicate the operating mode of switch 20. For example, the indicator circuit 260 includes an indicator light, when the operating mode of switch 20 is the first mode, it is indicated by the indicator light being “on”, and when the operating mode of switch 20 is the second mode, it is indicated by the indicator light being “off”. Of course, in other embodiments, the indicator circuit 260 can include indicator lights of different colors, and can also include buzzers, buttons, etc., without being limited to this.

The communication circuit is used for communication between all circuits in switch 20. Of course, in other embodiments, the communication circuit can also be integrated into the control circuit, without being limited to this.

Based on the above one or more functional circuits, when the operating mode of switch 20 is the first mode, switch 20 draws power from the live terminal of switch 20 through the first power extraction circuit, at this time, it is necessary to reduce the power consumption of various functional circuits inside switch 20, for example, the communication module reduces radio frequency transmission power and communication frequency, closes the metering function of the metering circuit, and lowers the brightness of the indicator light, thereby achieving the purpose of reducing power consumption and avoiding the “ghost fire” phenomenon.

When the operating mode of switch 20 is the second mode, switch 20 draws power from the live terminal and neutral terminal of switch 20 through the second power extraction circuit, since there is no need to consider the “ghost fire” issue, various functional circuits inside switch 20 can work at the highest performance level, for example, the communication module transmits radio frequency signals at full power and maintains communication, activates the metering circuit to measure and report power consumption data, and the indicator light is at maximum brightness, ensuring that switch 20 enters the second power consumption mode.

Current universal single-with neutral switch cannot achieve load metering functionality.

The control modules, communication modules, and other functional modules inside the smart switch require continuous power supply. With neutral switches have a separate circuit to provide working current for the switch, but no-neutral switches need to borrow the load to form a circuit to provide working current for the switch, which can easily lead to the “ghost fire” phenomenon.

To solve this problem, one solution is to use a battery to provide working current for the no-neutral switch, which does not affect the load, but requires periodic battery replacement, which is very inconvenient and has poor feasibility.

Another solution is to minimize the power consumption of the switch to avoid the ghost fire problem, making the no-neutral switch have to give up some functional modules, for example, the working power of the load metering module is about 1 mW, if it works in the no-neutral switch, it will cause the ghost fire phenomenon, and the no-neutral switch has to give up the load metering function. Universal single-with neutral switch are essentially still no-neutral switches, and current universal switches still cannot achieve load metering functionality.

As can be seen from the above, there is still a deficiency in the related technology where universal single-with neutral switch cannot achieve load metering functionality.

To make the objectives, technical solutions, and advantages of the present application clearer, further detailed descriptions of the embodiments of the present application will be provided in conjunction with the accompanying drawings.

Please refer to FIG. 8, the present embodiment of the application provides a switch 100, which includes: a first detection circuit 102, a second detection circuit 104, a metering circuit 106, and a control circuit 108.

The first detection circuit 102 is configured to detect the operating mode of switch 100.

The operating modes of switch 100 include a first mode and a second mode. The switch 100 provided by the present application is a universal single-with neutral switch, capable of operating in a no-neutral mode or a with neutral mode. The first mode refers to the no-neutral mode, and the second mode refers to the with neutral mode.

In one possible implementation, the first detection circuit 102 determines the operating mode of switch 100 by detecting whether switch 100 is connected to the neutral wire.

The second detection circuit 104 is configured to detect the power extraction method of switch 100.

The power extraction methods of switch 100 include a first power extraction method and a second power extraction method. Optionally, the first power extraction method refers to the on-state power extraction method, and the second power extraction method refers to the off-state power extraction method.

In one possible implementation, the second detection circuit 104 determines the power extraction method of switch 100 by detecting the power supply signal output by the power supply circuit.

The control circuit 108 is connected to the metering circuit 106 and is configured to control the metering circuit 106 to initiate load metering functions based on the operating mode and/or power extraction method of switch 100.

The metering circuit 106 has a load metering function and can measure the electrical parameters of the load, such as voltage, current, power, energy consumption, etc., without specific limitation.

In one possible implementation, the metering circuit 106 may include an energy metering chip, such as the power metering chip HLW8012, without specific limitation.

In one possible implementation, the control circuit 108 receives output signals from the first detection circuit 102 and the second detection circuit 104, determines the operating mode and/or power extraction method of switch 100, makes decisions, and controls the metering circuit 106 to complete the corresponding operations.

Specifically, if the operating mode of switch 100 is the second mode (with neutral mode), the control circuit 108 controls the metering circuit 106 to activate the load metering function and collect the electrical parameters of the load (such as power consumption); if the operating mode of switch 100 is the first mode (no-neutral mode) and the power extraction method is the first power extraction method (on-state power extraction), the control circuit 108 controls the metering circuit 106 to activate the load metering function and collect the electrical parameters of the load (such as power consumption), and can also be used as an overload protection; if the operating mode of switch 100 is the first mode (no-neutral mode) and the power extraction method is the second power extraction method (off-state power extraction), the control circuit 108 controls the metering circuit 106 to deactivate the load metering function to avoid the “ghost fire” phenomenon.

In one possible implementation, the control circuit 108 is a component capable of processing and executing control algorithms, such as an MCU (Microcontroller Unit).

Through the above embodiment, a switch is provided, which includes: a first detection circuit, a second detection circuit, a metering circuit, and a control circuit; wherein, the first detection circuit is configured to detect the operating mode of the switch, the second detection circuit is configured to detect the power extraction method of the switch, and the control circuit is configured to control the metering circuit to initiate load metering functions based on the operating mode and/or power extraction method of the switch. The switch determines the operating mode and power extraction method through the first detection circuit and the second detection circuit, and then controls whether the metering circuit works based on the operating mode and/or power extraction method. It can control the metering circuit to work normally under the second mode (when the switch is connected to the neutral wire), activate the load metering function, and collect the electrical parameters of the load (such as power consumption); it can also further control whether the metering circuit works under the first mode (when the switch is not connected to the neutral wire) based on the power extraction method, control the metering circuit to work normally under the first power extraction method (when the load is on), activate the load metering function, and collect the electrical parameters of the load (such as power consumption), and use it as an overload protection, and deactivate the load metering function under the second power extraction method (when the load is off) to reduce the power consumption of the switch and avoid the “ghost fire” phenomenon. Compared to the existing technology where only with neutral switches have load metering functions, the switch provided by the present application scheme enables universal single-with neutral switches to achieve load metering functions while avoiding ghost fire issues, thereby effectively solving the problem that universal single-with neutral switches in related technologies cannot achieve load metering functions.

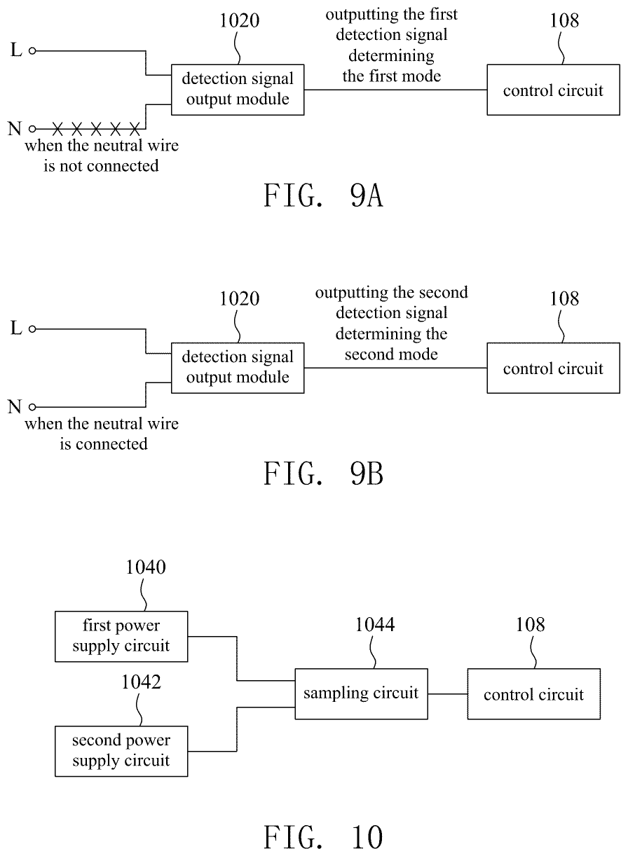

Please refer to FIGS. 9A and 9B, in an exemplary embodiment, the first detection circuit 102 includes a detection signal output module 1020.

L represents the live wire, and N represents the neutral wire.

In FIG. 9A, the detection signal output module 1020 outputs a first detection signal when switch 100 is not connected to the neutral wire and transmits the first detection signal to the control circuit 108, causing the control circuit 108 to determine that the operating mode of switch 100 is the first mode (no-neutral mode).

In FIG. 9B, the detection signal output module 1020 outputs a second detection signal when switch 100 is connected to the neutral wire and transmits the second detection signal to the control circuit 108, causing the control circuit 108 to determine that the operating mode of switch 100 is the second mode (with neutral mode).

The form of the first detection signal and the second detection signal can vary according to actual conditions, for example, the first detection signal and the second detection signal can be level signals, voltage signals, or serial port signals, without specific limitation.

In one possible implementation, when switch 100 is not connected to the neutral wire, the detection signal output module 1020 does not form a closed-loop circuit with the power grid, the detection signal output module 1020 does not work, and outputs a low-level signal (the first detection signal), at which time the control circuit 108 identifies it as the no-neutral mode; when switch 100 is connected to the neutral wire, the detection signal output module 1020 forms a closed-loop circuit with the power grid, the detection signal output module 1020 works, and outputs a high-level signal (the second detection signal), at which time the control circuit 108 identifies it as the with neutral mode.

In one possible implementation, the detection signal output module 1020 can be implemented through a voltage divider circuit, the AC voltage in the power grid after rectification is transmitted to the ADC detection pin of the control circuit 108 through the voltage divider, at this time, the first detection signal and the second detection signal are voltage signals, enabling the control circuit 108 to determine whether the neutral wire is connected by detecting the voltage value, and determine the operating mode of the switch.

Please refer to FIG. 10, in an exemplary embodiment, the second detection circuit 104 includes a first power supply circuit 1040, a second power supply circuit 1042, and a sampling circuit 1044.

The first power supply circuit 1040, when switch 100 is electrically connected to the load, outputs a first power supply signal to the sampling circuit 1044, allowing the sampling circuit 1044 to sample the first power supply signal.

The second power supply circuit 1042, when switch 100 is electrically disconnected from the load, outputs a second power supply signal to the sampling circuit 1044, allowing the sampling circuit 1044 to sample the second power supply signal.

Switch 100 being electrically connected to the load means that switch 100 controls the load to be connected to the power grid, i.e., the load is in the on state; switch 100 being electrically disconnected from the load means that switch 100 controls the load to be disconnected from the power grid, i.e., the load is in the off state.

The first power supply signal and the second power supply signal can be voltage signals, without specific limitation.

The sampling circuit 1044 samples the first power supply signal or the second power supply signal to output a sampling signal and transmits the sampling signal to the control circuit 108, allowing the control circuit 108 to determine the power extraction method of switch 100 based on the sampling signal.

It should be understood that when switch 100 is electrically connected to the load (i.e., the load is turned on), the first power supply circuit 1040 operates, converting the grid voltage into a low-voltage supply signal for powering the switch; when switch 100 is electrically disconnected from the load (i.e., the load is turned off), the second power supply circuit 1042 operates, converting the grid voltage into a low-voltage supply signal for powering the switch. The power supply signal can be sampled by the sampling circuit 1044, and the sampling results can be transmitted to the control circuit 108 to facilitate the control circuit 108 in determining the power extraction method of switch 100.

In one possible implementation, as shown in FIG. 11, the first power supply circuit 1040 includes a first power supply conversion component 10400 and a first power supply switch component 10402, wherein the first power supply conversion component 10400 converts the AC supply voltage into a first power supply voltage, which is then transmitted to the sampling circuit 1044 through the first power supply switch component 10402; the second power supply circuit 1042 includes a second power supply conversion component 10420 and a second power supply switch component 10422, wherein the second power supply conversion component 10420 converts the AC supply voltage into a second power supply voltage, which is then transmitted to the sampling circuit 1044 through the second power supply switch component 10422.

L represents the live wire, and N represents the neutral wire.

Optionally, the first power supply conversion component 10400 and the second power supply conversion component 10420 can be AC/DC converters, and the first power supply switch component 10402 and the second power supply switch component 10422 can be diodes, without specific limitation.

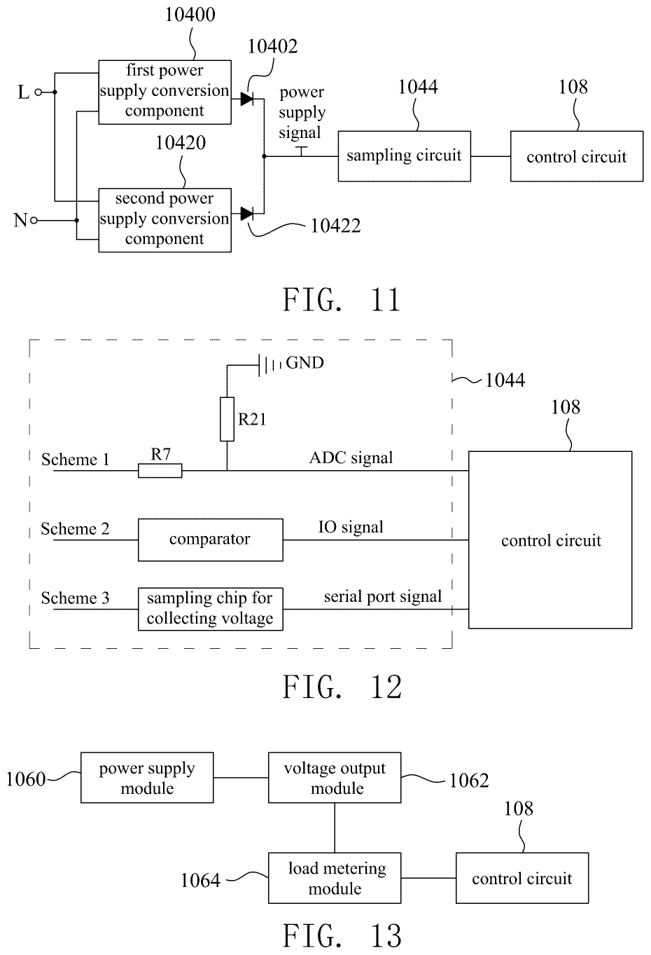

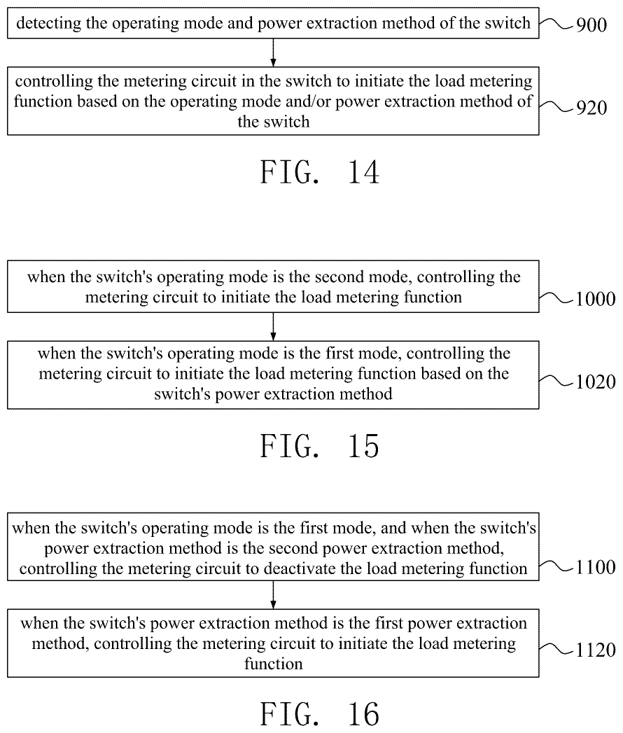

In one possible implementation, as shown in FIG. 12, it illustrates a schematic diagram of the specific implementation of the sampling circuit 1044.

FIG. 12 provides three schemes.

Scheme 1: The sampling circuit 1044 includes a first current-limiting component R7 and a second current-limiting component R21, one end of the first current-limiting component R7 is connected in series with one end of the second current-limiting component R21, the other end of the first current-limiting component R7 is connected to the first power supply circuit and the second power supply circuit (to receive the power supply signal), the other end of the second current-limiting component R21 is grounded, and the sampling signal is output at the series connection point of the first current-limiting component R7 and the second current-limiting component R21.

Therein, the power supply signal is sampled through voltage division, and correspondingly, the control circuit 108 detects the sampled signal after voltage division through an ADC.

Scheme 2: The sampling circuit 1044 includes a comparator, which is connected to the first power supply circuit and the second power supply circuit (to receive the power supply signal), compares the first power supply signal or the second power supply signal with a threshold signal, generates a sampling signal, and transmits it to the control circuit 108.

Therein, the magnitudes of the first power supply signal and the second power supply signal are different. By comparing the power supply signal with the threshold voltage, it can be determined whether the power supply signal is the first power supply signal or the second power supply signal, i.e., determining whether the power extraction method is the first power extraction method or the second power extraction method.

In the scheme using a comparator, the sampling signal is a high or low level, and the control circuit 108 can complete the judgment using a standard IO pin.

Scheme 3: A sampling chip is used to collect the power supply signal, which is then transmitted to the control circuit 108.

In the aforementioned embodiments, specific implementation methods of the second detection circuit are provided, enabling the switch to detect its power extraction method.

Please refer to FIG. 13, in an exemplary embodiment, the metering circuit 106 includes a power supply module 1060, a voltage output module 1062, and a load metering module 1064.

The power supply module 1060 is connected to the voltage output module 1062 and is used to output power supply voltage to the voltage output module 1062.

The voltage output module 1062 is connected to the control circuit 108 and is used, under the control of the control circuit 108, to supply power to the load metering module 1064 based on the power supply voltage output by the power supply module 1060.

The load metering module 1064 measures the electrical parameters of the load and transmits the measured parameters to the control circuit 108.

The power supply module 1060 can be an AC/DC converter, converting grid voltage into power supply voltage.

The load metering module 1064 can implement load metering functions, used to measure electrical parameters such as voltage, current, and power consumption. In one possible implementation, the load metering module 1064 includes a power metering chip HLW8012, which can measure active power, energy consumption, root mean square (RMS) voltage, RMS current, and other electrical parameters.

The voltage output module 1062, under the control of the control circuit 108, supplies power to the load metering module 1064 or stops supplying power to the load metering module 1064, thereby controlling whether the load metering module 1064 works or enters sleep mode.

In one possible implementation, the metering circuit 106 includes a power supply module 1060, a voltage output module 1062, and a load metering module 1064.

The power supply module 1060 includes a live wire L, a neutral wire N, and VOUT, converting the grid voltage (220V AC) into a power supply voltage (low-voltage DC) to supply power to the load metering module 1064. Optionally, the power supply module 1060 is an AC/DC converter.

In this embodiment, the voltage output module 1062 includes a third power supply switch component, which is optionally a Metal-Oxide-Semiconductor Field-Effect Transistor (MOSFET).

One end of the third power supply switch component is connected to the power supply module 1060, the other end is connected to the load metering module 1064, and the control terminal is connected to the control circuit 108. The control circuit 108 controls the conduction of the third power supply switch component, allowing the power supply voltage output by the power supply module 1060 to be transmitted to the load metering module 1064.

In other words, the control circuit 108 can control the operation of the load metering module 1064, i.e., turn the load metering function on or off, by controlling the conduction or disconnection of the third power supply switch component, thereby controlling the power consumption of the switch.

The load metering module 1064 includes a power metering chip and peripheral circuits. Specifically, a sampling resistor is connected in series in the input main circuit, forming a loop with L, L1, and the sampling resistor. The current flowing through the sampling resistor creates a voltage difference, and the power metering chip collects the voltage signal across the sampling resistor. The current value is calculated differentially. The grid voltage is reduced through a resistor, without exceeding the chip's voltage withstand limit, allowing the power metering chip to detect the input voltage. The power metering chip internally calculates the current and power and reports it to the control circuit 108 through pins.

Optionally, after obtaining various electrical parameters from the load metering module 1064, the control circuit 108 can upload them to the cloud (or server) and then push them to the client, enabling the switch to report load metering.

In one possible implementation, the voltage output module 1062 includes a Linear Regulator (LDO).

The input end of the linear regulator is connected to the power supply module 1060, the output end supplies power to the load metering module 1064, and the enable terminal (EN pin) of the linear regulator is connected to the control circuit 108.

The control circuit 108 controls the linear regulator to supply power to the load metering module 1064 by controlling the enable terminal of the linear regulator.

In this embodiment, the power supply module 1060 is powered by the live wire L and the neutral wire N, outputs power supply voltage to operate the linear regulator, provides VDD power supply for the power metering chip, and the enable (EN pin) of the linear regulator is controlled by the control circuit 108: when the control circuit 108 pulls the enable EN high, the VOUT pin of the linear regulator outputs 5V for use by the VDD pin of the power metering chip; when the control circuit 108 pulls the enable EN low, the linear regulator stops outputting, the VDD voltage of the power metering chip is 0, and the power metering chip cannot work.

Through the cooperation of the above embodiments, the voltage output module 1062 can have different implementation methods, such as using a third power supply switch component (MOSFET) or a linear regulator. Thereby, the control circuit 108 can control whether the voltage output module 1062 outputs power supply voltage to control the operation of the load metering module 1064, i.e., turn the load metering function on or off, thereby controlling the power consumption of the switch. This allows controlling the load metering function to be turned off in no-neutral mode and off-state power extraction method (second power extraction method) to avoid ghost fire issues, and to turn on the load metering function in other operating modes and power extraction methods, to report the energy consumption of various loads, etc. This enables universal single-with neutral switches to achieve load metering functions while avoiding ghost fire issues, thus effectively solving the problem that universal single-with neutral switches in related technologies cannot achieve load metering functions.

Please refer to FIG. 14, which illustrates a load metering function control method applied to the switch described above, the method includes the following steps:
Step 900, detecting the operating mode and power extraction method of the switch.

The operating modes include a first mode and a second mode, and the power extraction methods include a first power extraction method and a second power extraction method.

The first mode refers to the no-neutral mode, the second mode refers to the with neutral mode; the first power extraction method refers to the on-state power extraction method, and the second power extraction method refers to the off-state power extraction method.

Step 920, controlling the metering circuit in the switch to initiate the load metering function based on the operating mode and/or power extraction method of the switch.

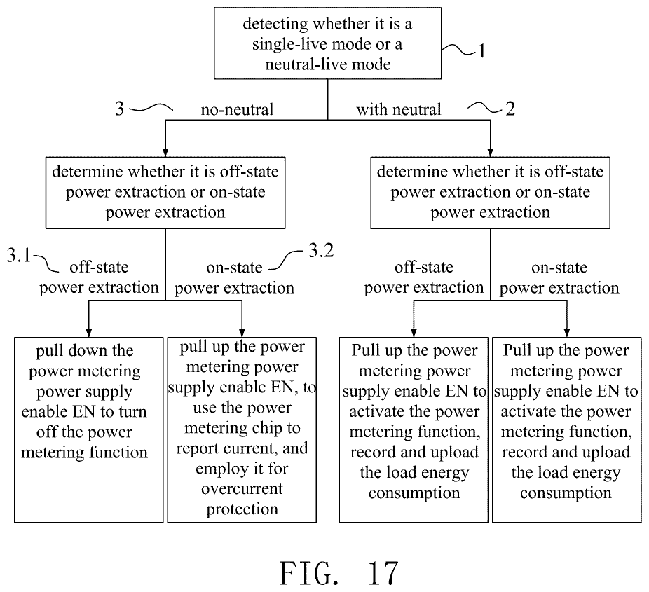

In one possible implementation, as shown in FIG. 15, step 920 includes the following steps:
Step 1000, when the switch's operating mode is the second mode, controlling the metering circuit to initiate the load metering function.

Step 1020, when the switch's operating mode is the first mode, controlling the metering circuit to initiate the load metering function based on the switch's power extraction method.

In one possible implementation, as shown in FIG. 16, step 1020 includes the following steps:
Step 1100, when the switch's operating mode is the first mode, and when the switch's power extraction method is the second power extraction method, controlling the metering circuit to deactivate the load metering function.

Step 1120, when the switch's power extraction method is the first power extraction method, controlling the metering circuit to initiate the load metering function.

Under the operation of the above embodiments, the metering circuit is controlled to initiate the load metering function based on the operating mode and/or power extraction method of the switch, to avoid the appearance of ghost fire phenomena, while also achieving the load metering function.

In an application scenario, as shown in FIG. 17, it illustrates the implementation process of the load metering function control method in an example:
1. First, detecting whether it is a no-neutral mode or a with neutral mode.
2. When it is a with neutral mode, turning on the power metering function (also known as the load metering function).
3. When it is a no-neutral mode, further determine whether it is off-state power extraction or on-state power extraction.
3.1. When it is off-state power extraction, turning off the power metering function.
3.2. When it is on-state power extraction, turning on the power metering function.

In this application scenario, the MCU can control whether the LDO outputs power supply voltage to control the operation of the power metering chip, that is, to control whether the load metering function is turned on or off, thereby controlling the power consumption of the switch. Thus, in the no-neutral mode and off-state power extraction method, control is used to turn off the load metering function to avoid ghost fire issues. In other operating modes and power extraction methods, control is used to turn on the load metering function to report the energy consumption of various loads, etc. This enables the single/with neutral universal switch to achieve load metering functions while avoiding ghost fire issues, thereby effectively solving the problem that single/with neutral universal switches in related technologies cannot achieve load metering functions.

Compared to related technologies, this application can produce the following benefits:
1. It provides a switch that includes: a first detection circuit, a second detection circuit, a metering circuit, and a control circuit; where the first detection circuit is used to detect the operating mode of the switch, the second detection circuit is used to detect the power extraction method of the switch, and the control circuit is used to control the metering circuit to initiate the load metering function based on the operating mode and/or power extraction method of the switch. This switch determines the operating mode and power extraction method through the first and second detection circuits, and then controls whether the metering circuit works based on the operating mode and/or power extraction method. It can control the metering circuit to work normally under the second mode (when the switch is connected to the neutral wire), initiate the load metering function, and collect the electrical parameters of the load (such as power consumption); it can also further control whether the metering circuit works under the first mode (when the switch is not connected to the neutral wire) based on the power extraction method, control the metering circuit to work normally under the first power extraction method (when the load is on), initiate the load metering function, and collect the electrical parameters of the load (such as power consumption), and use it as an overload protection, and deactivate the load metering function under the second power extraction method (when the load is off) to reduce the power consumption of the switch and avoid “ghost fire” phenomena. Compared to existing technologies where only with neutral switches have load metering functions, the switch provided by this application scheme enables single/with neutral universal switches to achieve load metering functions while avoiding ghost fire issues, thereby effectively solving the problem that single/with neutral universal switches in related technologies cannot achieve load metering functions.
2. The MCU can control whether the LDO outputs power supply voltage to control the operation of the power metering chip, that is, to control whether the load metering function is turned on or off, thereby controlling the power consumption of the switch. Thus, in the no-neutral mode and off-state power extraction method, control is used to turn off the load metering function to avoid ghost fire issues. In other operating modes and power extraction methods, control is used to turn on the load metering function to report the energy consumption of various loads, etc. This enables the single/with neutral universal switch to achieve load metering functions while avoiding ghost fire issues, thereby effectively solving the problem that single/with neutral universal switches in related technologies cannot achieve load metering functions.

It should be understood that although the steps in the flowcharts of the figures are displayed sequentially according to the arrows, these steps are not necessarily executed in the order indicated by the arrows. Unless explicitly stated in this document, there is no strict order restriction on the execution of these steps, and they can be executed in other orders. Moreover, at least some of the steps in the flowcharts of the figures can include multiple sub-steps or stages, which are not necessarily completed at the same time but can be executed at different times, and their execution order is not necessarily sequential but can be alternately executed with at least some of the other steps or sub-steps or stages.

The above description is merely of some embodiments of the present application. It should be noted that for ordinary technicians in this technical field, several improvements and modifications can still be made without departing from the principles of the present application. These improvements and modifications should also be considered as within the scope of protection of the present application.

What is claimed is:

1. A switch, wherein the switch comprises a first detection circuit, a control circuit, and a power extraction circuit; wherein,
the first detection circuit, is configured to detect an operating mode of the switch; the operating mode comprises a first mode and a second mode;
the control circuit, is connected to the first detection circuit and the power extraction circuit, and is configured to control the power extraction circuit to draw power according to a corresponding power extraction mode based on the operating mode of the switch.

2. The switch as claimed in claim 1, wherein the first detection circuit comprises a detection signal output module;
the detection signal output module is configured to output a first detection signal when the switch is not connected to a neutral wire, and transmit the first detection signal to the control circuit, causing the control circuit to determine the operating mode of the switch as the first mode; or, to output a second detection signal when the switch is connected to a neutral wire, and transmit the second detection signal to the control circuit, causing the control circuit to determine the operating mode of the switch as the second mode.

3. The switch as claimed in claim 2, wherein the first detection circuit further comprises a voltage input module and an isolation module;
wherein, the voltage input module is configured to transmit a high voltage signal to the isolation module when a neutral wire terminal of the switch is connected to the neutral wire; or, to stop transmitting the high voltage signal to the isolation module when the neutral wire terminal of the switch is not connected to the neutral wire;
the isolation module is configured to generate a first low voltage signal or a second low voltage signal based on whether the voltage input module outputs the high voltage signal, and transmit the first low voltage signal or the second low voltage signal to the detection signal output module;
the detection signal output module is configured to correspondingly generate a detection signal based on the first low voltage signal or the second low voltage signal, and transmit the detection signal to the control circuit, causing the control circuit to determine the operating mode of the switch based on the detection signal.

4. The switch as claimed in claim 3, wherein the isolation module comprises an optocoupler unit; wherein,
when an input terminal of the optocoupler unit receives the high voltage signal output by the voltage input module, an output terminal of the optocoupler unit is conductive, to generate the first low voltage signal;
when the input terminal of the optocoupler unit does not receive the high voltage signal output by the voltage input module, the output terminal of the optocoupler unit is disconnected, to generate the second low voltage signal.

5. The switch as claimed in claim 2, wherein the detection signal output module comprises a detection switch element and a detection-limiting current element; wherein,
a control terminal of the detection switch element is configured to receive the first low voltage signal or the second low voltage signal, causing an input terminal and an output terminal of the detection switch element is conductive or disconnected based on the first low voltage signal or the second low voltage signal;
one terminal of the detection-limiting current element is connected to the output terminal of the detection switch element, and an other terminal connected to a power supply terminal, configured to correspondingly output the detection signal when the detection switch element is conductive or disconnected.

6. The switch as claimed in claim 1, wherein the power extraction circuit is connected to a live wire terminal and/or a neutral wire terminal of the switch, configured to draw power according to the power extraction mode corresponding to the operating mode of the switch and supply power to the switch;
the power extraction circuit comprises a first power extraction circuit and a second power extraction circuit;
when the operating mode of the switch is the first mode, the first power extraction circuit draws power from the live wire terminal of the switch according to the first power extraction mode corresponding to the first mode, causing the switch to enter a first power consumption mode;
when the operating mode of the switch is the second mode, the second power extraction circuit draws power from the live wire terminal and the neutral wire terminal of the switch according to the second power extraction mode corresponding to the second mode, causing the switch to enter a second power consumption mode; power consumption in the second power consumption mode is higher than that in the first power consumption mode.

7. The switch as claimed in claim 6, wherein the first power extraction circuit comprises a first power extraction conversion component and a first power extraction switch component, wherein, through the first power extraction conversion component, an input voltage of the first power extraction circuit is converted into a first voltage, and the switch is powered through the first power extraction switch component;
the second power extraction circuit comprises a second power extraction conversion component and a second power extraction switch component, wherein, through the second power extraction conversion component, input voltage of the second power extraction circuit is converted into a second voltage, and the switch is powered through the second power extraction switch component.

8. The switch as claimed in claim 1, wherein the switch further comprises a relay control circuit connected to the control circuit, the relay control circuit comprises a relay, the relay control circuit is configured to control the relay to conduct under control of the control circuit, to control operation of a load connected to the switch by conduction of the relay.

9. The switch as claimed in claim 1, wherein the switch a functional circuit connected to the power extraction circuit; a power extraction modes comprise a first power extraction mode and a second power extraction mode; wherein, the power extraction circuit, under the first power extraction mode, is configured to output a first voltage to the functional circuit; or, under the second power extraction mode, is configured to output a second voltage to the functional circuit; the first voltage is lower than the second voltage.

10. The switch as claimed in claim 9, wherein the functional circuit comprises at least one of the following:
a metering circuit, configured to measure electrical parameters of a load connected to the switch;
an indication circuit, configured to indicate the operating mode of the switch;
a communication circuit, configured to communicate between all circuits within the switch.

11. The switch as claimed in claim 1, wherein the switch further comprises: a second detection circuit and a metering circuit, the second detection circuit is configured to detect a power extraction method of the switch; the power extraction method comprises a first power extraction method and a second power extraction method;
the control circuit, is connected to the metering circuit, and is configured to control the metering circuit to a load metering function, based on the operating mode and/or the power extraction method of the switch.

12. The switch as claimed in claim 11, wherein the second detection circuit comprises a first power supply circuit, a second power supply circuit, and a sampling circuit; wherein,
the first power supply circuit, is configured to output a first power supply signal to the sampling circuit when the switch is electrically connected to a load, causing the sampling circuit to sample the first power supply signal;
the second power supply circuit, is configured to output a second power supply signal to the sampling circuit when the switch is disconnected from the load, causing the sampling circuit to sample the second power supply signal;
the sampling circuit, configured to output a sampling signal by sampling the first power supply signal or the second power supply signal, and transmit the sampling signal to the control circuit, causing the control circuit to determine the power extraction method of the switch based on the sampling signal.

13. The switch as claimed in claim 12, wherein the first power supply circuit comprises a first power supply conversion component and a first power supply switch component, wherein, through the first power supply conversion component, a AC supply voltage is converted into a first power supply voltage, which is then transmitted to the sampling circuit via the first power supply switch component; and/or
the second power supply circuit comprises a second power supply conversion component and a second power supply switch component, wherein, through the second power supply conversion component, the AC supply voltage is converted into a second power supply voltage, which is then transmitted to the sampling circuit via the second power supply switch component.

14. The switch as claimed in claim 12, wherein the sampling circuit comprises a comparator, the comparator is connected to the first power supply circuit and the second power supply circuit, is configured to compare the first power supply signal or the second power supply signal with a threshold signal, generate a sampling signal, and transmit it to the control circuit; and/or
the sampling circuit comprises a first current-limiting component and a second current-limiting component, one terminal of the first current-limiting component and one terminal of the second current-limiting component are connected in series, an other terminal of the first current-limiting component is connected to the first power supply circuit and the second power supply circuit, an other terminal of the second current-limiting component is grounded, and the sampling signal is output at a series connection point of the first current-limiting component and second current-limiting component.

15. The switch as claimed in claim 11, wherein the metering circuit comprises a power supply module, a voltage output module, and a load metering module; wherein,
the power supply module, connected to the voltage output module, is configured to output a power supply voltage to the voltage output module;
the voltage output module, connected to the control circuit, is configured to supply power to the load metering module based on the power supply voltage outputted by the power supply module under control of the control circuit;
the load metering module, configured to measure electrical parameters of the load and transmit measured electrical parameters to the control circuit.

16. The switch as claimed in claim 15, wherein the voltage output module comprises a linear regulator;
an input terminal of the linear regulator is connected to the power supply module, an output terminal of the linear regulator supplies power to the load metering module, and an enable terminal of the linear regulator is connected to the control circuit;
the control circuit controls the enable terminal of the linear regulator, to control linear regulator supply power to the load metering module.

17. The switch as claimed in claim 15, wherein the voltage output module comprises a third power supply switch component;
one terminal of the third power supply switch component is connected to the power supply module, an other terminal of the third power supply switch component is connected to the load metering module, and a control terminal of the third power supply switch component is connected to the control circuit;
the control circuit is configured to control the third power supply switch component to conduct, causing the power supply voltage outputted by the power supply module transmitted to the load metering module.

18. A load metering function control method, applied to the switch as claimed in claim 11, the method comprising:
detecting the operating mode and the power extraction method of the switch;
controlling the metering circuit within the switch to initiate the load metering function based on the operating mode and/or the power extraction method of the switch.

19. The method as claimed in claim 18, wherein controlling the metering circuit within the switch to initiate the load metering function based on the operating mode and/or the power extraction method of the switch comprises:
when the operating mode of the switch is the second mode, controlling the metering circuit to initiate the load metering function;
when the operating mode of the switch is the first mode, controlling the metering circuit to initiate the load metering function based on the power extraction method of the switch.

20. The method as claimed in claim 19, wherein, when the operating mode of the switch is the first mode, controlling the metering circuit to initiate the load metering function based on the power extraction method of the switch comprises:
when the operating mode of the switch is the first mode, and the power extraction method of the switch is the second power extraction method, controlling the metering circuit to deactivate the load metering function;
when the power extraction method of the switch is the first power extraction method, controlling the metering circuit to initiate the load metering function.
